(19) United States
(12) Patent Application Publication
(10) Pub. No.: US 2011/0226402 A1
(43) Pub. Date: Sep. 22, 2011

(54) Method for repurposing a tire

(76) Inventor: Maris Lans, Highland Park, IL (US)

(21) Appl. No.: 12/659,664

(22) Filed: Mar. 16, 2010

(51) Int. Cl. B29C 65/00; B44C 5/00

(52) U.S. Cl. 156/60

(57) ABSTRACT

An environmentally conscious method for repurposing or reusing tires. In lieu of shredding, burning, or burying otherwise non-biodegradable spent tires, they are repurposed for advertising, marketing, or decorative purposes, including covering the tires or painting and affixing additional elements to same to simulate generally any round, circular, or disk shaped object.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to methods for repurposing or recycling tires. More specifically, this invention combines used tires with specialty advertising and marketing products and services wherein the tires are incorporated into the marketing campaign.

### BACKGROUND OF THE INVENTION

By most estimates, Americans dispose of 190 million automobile, truck, and equipment tires every year and at any given time, approximately 2 billion of these used tires are languishing in various dumps and scrap yards around the country. Because they are manufactured from petrochemicals, disposal or recycling is difficult. They cannot easily be burned because of the tremendous amounts of hydrocarbons released into the atmosphere, nor can they be reliably retreaded, thereby allowing them to be reused. More problematically, they are not biodegradable. What is needed is a method to repurpose used tires in an environmentally friendly manner. Preferably, this method entails no significant expenditure of additional energy and can be accomplished with little or no additional cost.

### SUMMARY OF THE INVENTION

The present invention is a method for repurposing used tires whereby the spent tire is used in its entirety to create a marketing display. The tire is used as a base whereby it is covered or otherwise decorated in some manner to create an aesthetically pleasing display. In one version, the tire is mounted to a base and a tire cover, similar to those used on SUVs and other vehicles with externally mounted spare tires, is affixed in a conventional manner. A flower box or other open container is then affixed atop the tire and tire cover combination to create an aesthetically pleasing display. Alternatively, Greek or any language letters and/or numbers may be affixed to the tires. In yet another version, the circular shape of the tire itself is utilized to simulate another round object, for example, a life preserver, a coin, a ship's wheel, a hat, a clock, a bagel, a donut, a plate, a pizza, foodstuffs in a “takeout” canister, various warning signs, or a slice of fruit.

It is an object of the invention to repurpose used or spent tires to create an aesthetically pleasing display;

It is still another object of this invention to reduce to level of used or spent tires in landfills;

It is another object of this invention to repurpose used or spent tires in an environmentally friendly manner; and,

It is yet another object of this invention to repurpose used or spent tires in a manner that requires insignificant additional energy or cost.

### BRIEF DESCRIPTION OF THE DRAWINGS

FIG. 1 is an elevation view of the present invention;

FIG. 2 is an elevation view of an alternate embodiment of the present invention shown in FIG. 1;

FIG. 3 is an elevation view of yet another alternate embodiment of the present invention; and,

FIG. 4 is an elevation view of still another alternate embodiment of the present invention.

### DETAILED DESCRIPTION OF THE INVENTION

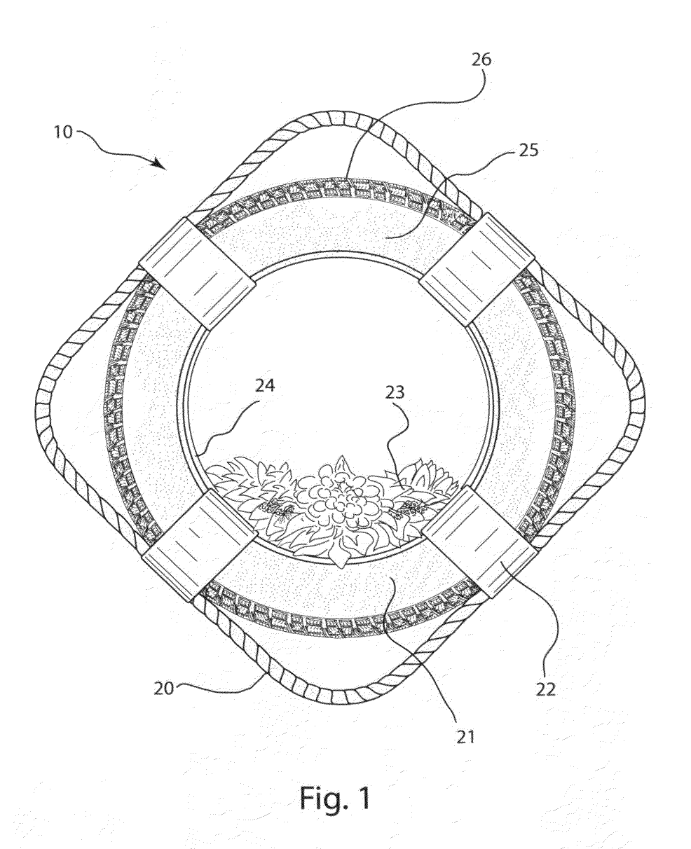

The preferred embodiments and best modes of the invention are shown in FIGS. 1 through 4. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

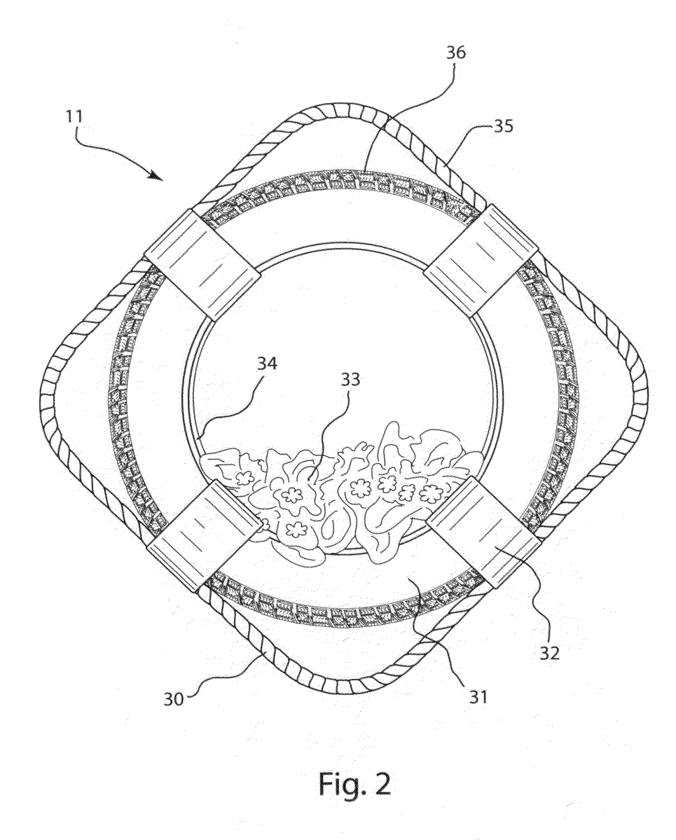

FIGS. 1 and 2 show the present invention in a conformation simulating a life preserver 10, 11. The tire 21, 31 is preferably painted in a primary color similar to those used with regard to life preservers. For example, in FIG. 2 the tire 31 is painted white. Alternatively, the tire 21, 31 may be painted such that its color coordinates with the decor of the environment in which it will be place. Turning to FIG. 1, in lieu of a traditional color used for life preservers, the tire 21 is painted blue in order to coordinate its color with that of the surrounding environment. Similarly, contrastingly colored retention straps 22, 32 are affixed at approximately 90 degree intervals about the periphery of the tires 21, 31 in order to secure a length of cable 20, 30 similar to those affixed about a genuine life preserver for use as a handhold. In FIG. 1 the strap 22 is yellow to contrast with the blue color of the tire 21. In FIG. 2, which is configured to closely simulate the appearance of an actual life preserver, the strap 32 is red, as would be the case with regard to the genuine article. In a preferred embodiment, the interior volume 24, 34 defined by the sidewalls 25, 35 and the tread 26, 36 of the tires 21, 31 is partially or completely filled with flowers 23, 33 or other aesthetically pleasing item. Thereafter, the now-repurposed tires, in this case simulating a life preserver 10, 11, are affixed to a wall in a conventional manner.

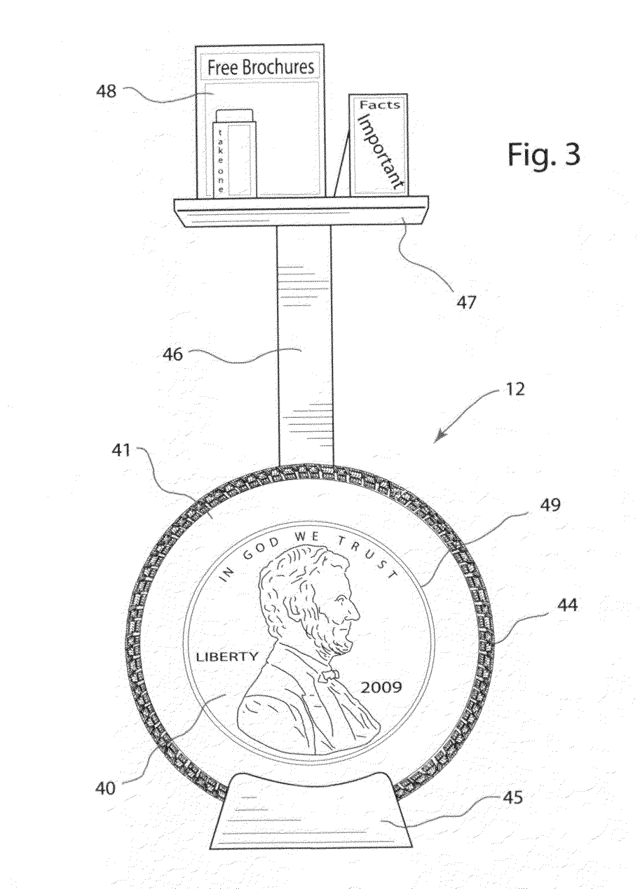

FIG. 3 is an alternative embodiment showing the invention mounted to a base. This embodiment may be used to simulate any generally disc-shaped item, for example a penny, whereby the simulation is generally larger-than-life size as dictated by the diameter of the tire 41 being repurposed. The tire 41 is mounted to a base 45 thereby permitting the apparatus 12 to be free standing. An insert 40 is then mounted in the diameter defined by the inside diameter 49 of the tire 41. The tire 41 is then painted in a color scheme that is complimentary to the insert 40. In practice, the insert 40 is generally sized to occlude the tire's inside diameter 49, but may be sized to range up to and including the outside diameter 44 of the tire 41. In FIG. 3, the insert 40 is formed to simulate the appearance of a penny. The tire 41 is painted in a similar copper color such that the entire apparatus 12 simulates an enlarged penny. This penny simulation is an ideal marketing device for use by, for example, a bank. Additionally, inserts 40 may be manufactured to simulate any round item. For example, a whole pizza, a dinner plate with the meal plated onto it, or a top view of a take-out food container may be used to promote a restaurant. Similarly, a cross sectional slice of an orange or apple may be used to promote a grocery or market. Thereafter, the tire 41 is painted in a manner that completes the effect of simulating the various items depicted in the insert 40. In a preferred embodiment, a stanchion 46 is mounted to the base such that the stanchion 46 is partially hidden by the tire 41. A display adjunct, for example a shelf 47, is then mounted atop the stanchion 46. Marketing materials 48 may be carried on the shelf 47, and the entire device 12 can thereby by used for promotional purposes.

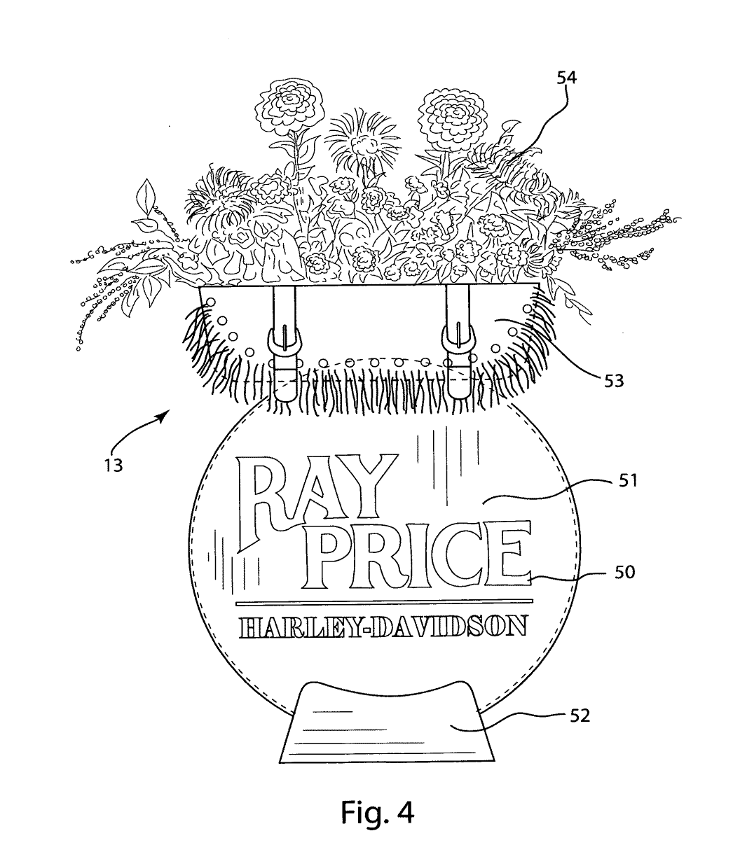

FIG. 4 shows yet another embodiment wherein the apparatus 13 simulates a spare tire and its cover similar to what might be found affixed to the rear of many sport utility vehicles (SUVs). In this version, a readily available tire cover 51 is simply mounted about the tire 50 in a conventional manner and the cover 51 and tire 50 combination are mounted to a base 52 that supports the apparatus as a free-standing device. Tire covers 51 are widely available and are commonly used to advertise various automobile, vehicle, and merchandise brands, and are easily obtained with any customized design. Thereafter, a display adjunct is mounted atop the tire 50 and cover 51 combination. Such adjuncts may comprise a shelf, or as shown in FIG. 4, comprise a flower box 53 dressed to complement the cover to which it is affixed. Flowers 54 are then placed in the box 53, thereby creating a pleasing decorative object from the previously spent tire.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1) A method for repurposing tires comprising:
selecting a circular object to simulate;
selecting a tire to use for simulating said circular object coloring said tire to simulate said circular object; and,
affixing simulating means to said tire.

2) A method for repurposing tires as claimed in claim 1 further comprising affixing decorative means to said tire.

3) A method for repurposing tires as claimed in claim 1 further comprising affixing a base to said tire such that it is self-supporting.

4) A method for repurposing tires as claimed in claim 3 further comprising affixing a stanchion to said base and affixing a shelf atop said stanchion.

5) A method for repurposing tires as claimed in claim 1 wherein said simulating means is a cable affixed to the periphery of said tire at least one point.

6) A method for repurposing tires as claimed in claim 1 wherein said circular object is a life preserver.

7) A method for repurposing tires as claimed in claim 1 wherein said simulating means is a simulated coin.

8) A method for repurposing tires as claimed in claim 1 wherein said circular object is a coin

9) A method for repurposing tires as claimed in claim 1 wherein said simulation is a larger-than-life simulation.

10) A method for repurposing tires as claimed in claim 9 wherein said larger-than-life simulation is taken from the group consisting of a cross sectional slice of fruit, a cross sectional slice of a generally round foodstuff, a pizza, a serving plate with foodstuffs thereon, and foodstuffs in a takeout canister.

11) A method for repurposing tires comprising:
selecting a tire;
covering said tire; and,
affixing display adjunct means to said cover.

12) A method for repurposing tires as claimed in claim 11 further comprising affixing a base to said tire such that it is self-supporting.

13) A method for repurposing tires as claimed in claim 11 wherein said cover is a tire cover.

14) A method for repurposing tires as claimed in claim 13 wherein said tire cover includes a marketing message.

15) A method for repurposing tires as claimed in claim 11 wherein said display adjunct means is a flower box affixed atop said tire and said cover.

16) A method for repurposing tires as claimed in claim 11 wherein said display adjunct means is a shelf affixed atop said tire and said cover.

17) A method for repurposing tires comprising:
selecting a circular object to simulate in a larger-than-life form;
selecting a tire to use for simulating said circular object coloring said tire to simulate said circular object;
affixing simulating means to said tire; and,
affixing a base to said tire such that it is self-supporting.

18) A method for repurposing tires as claimed in claim 17 wherein said larger-than-life simulation is taken from the group consisting of a cross sectional slice of fruit, a cross sectional slice of a generally round foodstuff a pizza, a serving plate with foodstuffs thereon, and foodstuffs in a takeout canister.

19) A method for repurposing tires as claimed in claim 17 wherein said simulating means is a larger-than-life, generally true-to-life image taken from the group consisting of a cross sectional slice of fruit, a cross sectional slice of a generally round foodstuff, a pizza, a serving plate with foodstuffs thereon, and foodstuffs in a takeout canister affixed about the aperture defined by the interior diameter of said tire.
